(19) United States
(12) Patent Application Publication
(10) Pub. No.: US 2022/0020051 A1
(43) Pub. Date: Jan. 20, 2022

(54) BENEFIT DISTRIBUTION APPARATUS, METHOD, AND NON-TRANSITORY COMPUTER READABLE MEDIUM

(71) Applicant: NEC Corporation, Minato-ku, Tokyo (JP)

(72) Inventors: Akane ARUGA, Tokyo (JP); Shigeki SHINODA, Tokyo (JP); Takumi OTANI, Tokyo (JP); Ikumi SAGA, Tokyo (JP); Yuzo SENDA, Tokyo (JP)

(73) Assignee: NEC Corporation, Minato-ku, Tokyo (JP)

(21) Appl. No.: 17/299,501

(22) PCT Filed: Sep. 18, 2019
(86) PCT No.: PCT/JP2019/036458

§ 371 Date: Jun. 3, 2021

(30) Foreign Application Priority Data
Dec. 6, 2018 (JP) 2018-229184

(51) Int. Cl. G06Q 30/02

(52) U.S. Cl. CPC G06Q 30/0235

(57) ABSTRACT

An arrival time acquisition unit acquires a time at which a user has arrived at an airport. A length of stay information generation unit calculates a length of stay based on the time at which the user has arrived and a scheduled boarding time of an aircraft on which the user is scheduled to board and generates length of stay information including the length of stay. A behavioral characteristic estimation unit estimates a behavioral characteristic of the user based on the generated length of stay information and a behavioral characteristic table. A benefit determination unit refers to a benefit information table and determines benefit information to be distributed to the user based on the estimated behavioral characteristic. A benefit transmission unit transmits the determined benefit information to a terminal apparatus carried by the user.

### TECHNICAL FIELD

The present disclosure relates to a benefit distribution apparatus, a method, and a non-transitory computer readable medium.

### BACKGROUND ART

In general, passengers who are scheduled to board an aircraft arrive at an airport before their scheduled boarding time and stay there for some time before departure. Shops, restaurants, and the like are located in the airport, and passengers can use them until their departure. By issuing coupons or the like for receiving a benefit, such as a discount, to passengers and allowing them to use the coupons or the like in the airport, use of the stores in the airport can be promoted, and an increase in sales can be expected.

In regard to the use of the stores in the airport, Patent Literature 1 discloses a guide apparatus for guiding a user, such as a passenger, to a store such as a souvenir shop or a restaurant. The guide apparatus disclosed in Patent Literature 1 calculates a length of stay of the user based on the scheduled boarding time of an aircraft used by the user and the time required for the user to move from his/her current position to the boarding place. The guide apparatus determines whether the length of stay is longer than a predetermined spare time. When the length of stay is longer than the predetermined spare time, the guide apparatus transmits, to a radio information terminal carried by the user, benefit data that is valid for a store in which the time required is shorter than the length of stay.

### CITATION LIST

### Patent Literature

Patent Literature 1: Japanese Unexamined Patent Application Publication No.

### SUMMARY OF INVENTION

### Technical Problem

Patent Literature 1 discloses that benefit data of a restaurant is transmitted to a user who stays for a long time, and benefit data of a souvenir shop is transmitted to a user who stays for a short time. However, the behavior of a user is not always influenced only by the length of stay and the time required in the store. For example, a user who stays for a long time may use a store in which the time required is short. In Patent Literature 1, since benefit data to be transmitted is determined based on the relation between the length of stay of a user and the time required in a store, benefit data that does not meet the needs of a user may be transmitted to the user.

In view of the above, one of the objects of the present disclosure is to provide a benefit distribution apparatus, a method, and a system that are capable of distributing benefit information that meets the needs of a user.

### Solution to Problem

In order to achieve the aforementioned object, the present disclosure provides a benefit distribution apparatus including: arrival time acquisition means for acquiring a time at which a user who is scheduled to board an aircraft has arrived at an airport; length of stay information generation means for calculating a length of stay based on the time at which the user has arrived at the airport and a scheduled boarding time of the aircraft on which the user is scheduled to board and generating length of stay information including the length of stay; behavioral characteristic estimation means for estimating a behavioral characteristic of the user based on a behavioral characteristic table in which length of stay information and behavioral characteristics of a user at the airport are stored in association with each other; benefit determination means for referring to a benefit information table in which the behavioral characteristic and one or more pieces of benefit information to be distributed are stored in association with each other and determining the benefit information to be distributed to the user based on the estimated behavioral characteristic; and benefit transmission means for transmitting the benefit information determined by the benefit determination means to a terminal apparatus carried by the user.

Further, the present disclosure provides a benefit distribution method including: acquiring a time at which a user who is scheduled to board an aircraft has arrived at an airport; calculating a length of stay based on the time at which the user has arrived at the airport and a scheduled boarding time of the aircraft on which the user is scheduled to board and generating length of stay information including the length of stay; estimating a behavioral characteristic of the user based on a behavioral characteristic table in which length of stay information and behavioral characteristics of a user at the airport are stored in association with each other; referring to a benefit information table in which the behavioral characteristic and one or more pieces of benefit information to be distributed are stored in association with each other and determining the benefit information to be distributed to the user based on the estimated behavioral characteristic; and transmitting the determined benefit information to a terminal apparatus carried by the user.

Furthermore, the present disclosure provides a non-transitory computer readable medium storing a program for causing a computer to: acquire a time at which a user who is scheduled to board an aircraft has arrived at an airport; calculate a length of stay based on the time at which the user has arrived at the airport and a scheduled boarding time of the aircraft on which the user is scheduled to board and generate length of stay information including the length of stay; estimate a behavioral characteristic of the user based a behavioral characteristic table in which length of stay information and behavioral characteristics of a user at the airport are stored in association with each other; refer to a benefit information table in which the behavioral characteristic and one or more pieces of benefit information to be distributed are stored in association with each other and determine the benefit information to be distributed to the user based on the estimated behavioral characteristic; and transmit the determined benefit information to a terminal apparatus carried by the user.

### Advantageous Effects of Invention

The benefit distribution apparatus, a method, and a non-transitory computer readable medium according to the present disclosure can distribute, to a user, benefit information that meets the needs of the user.

### BRIEF DESCRIPTION OF DRAWINGS

FIG. 1 is a block diagram showing a schematic configuration of a benefit distribution apparatus according to the present disclosure;

FIG. 2 is a block diagram showing a benefit distribution apparatus according to a first example embodiment of the present disclosure;

FIG. 3 is a block diagram showing an example of a passenger process in Fast Travel;

FIG. 4 is a block diagram showing a learning apparatus;

FIG. 5 is a diagram showing a specific example of data stored in a data accumulation unit of the learning apparatus;

FIG. 6 is a diagram showing a specific example of a table generated by a behavioral characteristic information generation unit;

FIG. 7 is a flowchart showing an operation procedure of the learning apparatus;

FIG. 8 is a diagram showing a specific example of a benefit information table;

FIG. 9 is a diagram showing another specific example of the benefit information table;

FIG. 10 is a flowchart showing an operation procedure of the benefit distribution apparatus;

FIG. 11 is a diagram showing a specific example of data accumulated in the learning apparatus; and

FIG. 12 is a block diagram showing a configuration example of a computer apparatus.

### DESCRIPTION OF EMBODIMENTS

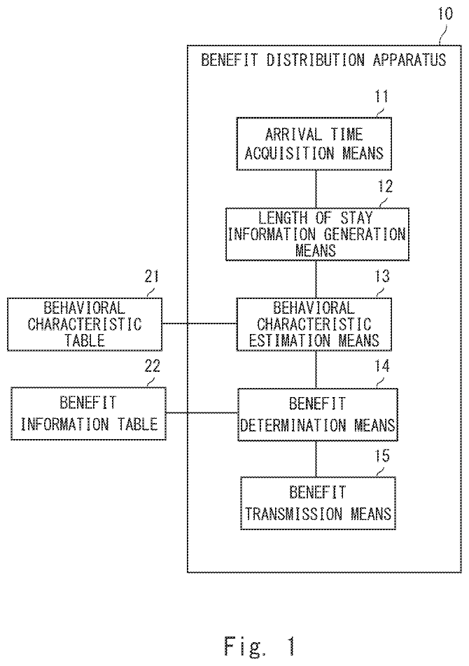

Prior to describing example embodiments according to the present disclosure, an overview of the example embodiments will be given. FIG. 1 shows a schematic configuration of a benefit distribution apparatus according to the present disclosure. A benefit distribution apparatus 10 includes arrival time acquisition means 11, length of stay information generation means 12, behavioral characteristic estimation means 13, benefit determination means 14, and benefit transmission means 15.

The arrival time acquisition means 11 acquires the time at which a user who is scheduled to board an aircraft has arrived at an airport. The length of stay information generation means 12 calculates a length of stay based on the time at which the user has arrived and the scheduled boarding time of the aircraft on which the user is scheduled to board and thereby generates length of stay information including the length of stay. A behavioral characteristic table 21 stores length of stay information and behavioral characteristics of a user at the airport in association with each other. The behavioral characteristic estimation means 13 estimates a behavioral characteristic of the user based on the length of stay information generated by the length of stay information generation means 12 and the behavioral characteristic table 21.

A benefit information table 22 stores a behavioral characteristic and one or more pieces of benefit information to be distributed in association with each other. The benefit information includes information such as coupon information that can be used in a store and the like. The benefit determination means 14 refers to the benefit information table 22 and determines benefit information to be distributed to a user based on the behavioral characteristic estimated by the behavioral characteristic estimation means 13. The benefit transmission means 15 transmits the benefit information determined by the benefit determination means 14 to a terminal apparatus carried by a user.

In the present disclosure, the behavioral characteristic estimation means 13 refers to the behavioral characteristic table 21 and estimates a behavioral characteristic of a user from the length of stay information. The benefit determination means 14 determines benefit information to be distributed to a user from the behavioral characteristic by using the benefit information table 22. It is considered that there is some correlation between the length of stay at an airport and the behavioral trend of an airport user. In the present disclosure, by connecting the length of stay information with the behavioral characteristic, it is possible to distribute benefit information that meets the needs of a user in accordance with the length of his/her stay.

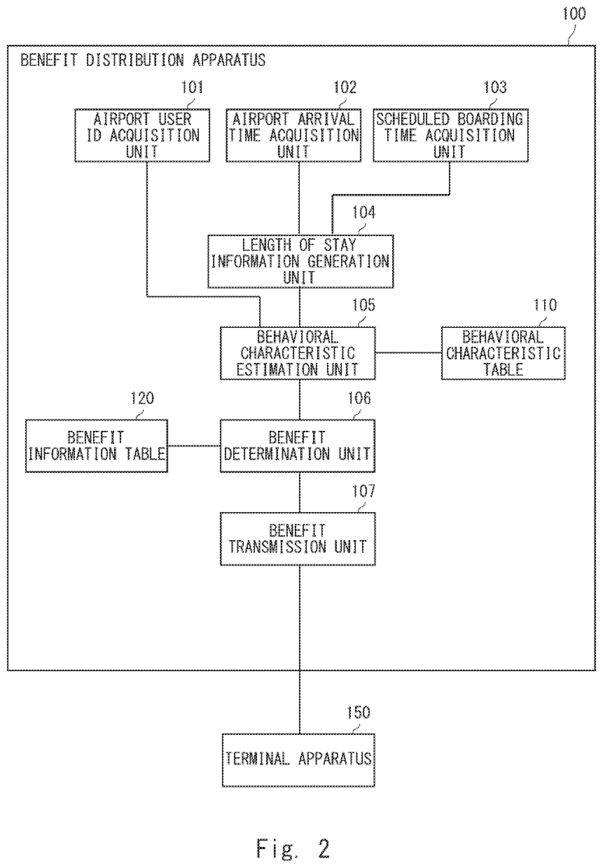

Hereinafter, example embodiments according to the present disclosure will be described in detail with reference to the drawings. FIG. 2 shows a benefit distribution apparatus according to a first example embodiment of the present disclosure. A benefit distribution apparatus 100 includes an airport user Identifier (ID) acquisition unit 101, an airport arrival time acquisition unit 102, a scheduled boarding time acquisition unit 103, a length of stay information generation unit 104, a behavioral characteristic estimation unit 105, a benefit determination unit 106, a benefit transmission unit 107, a behavioral characteristic table 110, and a benefit information table 120.

The airport user ID acquisition unit 101 acquires identification information (ID) for uniquely identifying a passenger (a user) who is scheduled to board an aircraft. The airport user ID acquisition unit 101 acquires, for example, the number of the passport of a user as identification information of an airport user. The scheduled boarding time acquisition unit 103 acquires a scheduled boarding time of the aircraft on which a user boards. It is assumed that the aircraft on which a user is scheduled to board is registered in advance in a server (not shown). The scheduled boarding time acquisition unit 103 may acquire the scheduled boarding time from, for example, operation information on the day.

The airport arrival time acquisition unit 102 acquires the time at which a user has arrived at the airport. The airport arrival time acquisition unit 102 acquires, as an airport arrival time, the earliest time from among, for example, the time at which the user has checked in at a check-in terminal installed in the airport, the time at which the user has checked his/her baggage in, and the time at which the user has passed through the security checkpoint. The airport arrival time acquisition unit 102 corresponds to the arrival time acquisition means 11 shown in FIG. 1.

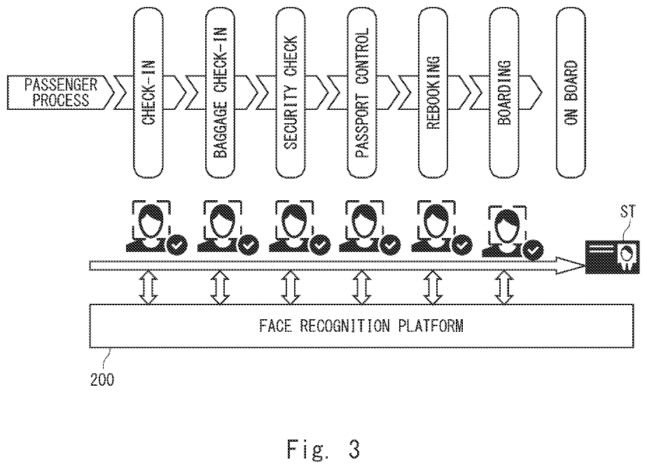

It should be noted that Fast Travel, which is a program of which the aim is to provide efficient and comfortable services by promoting the automation (self-service) of user procedures at airports, has been promoted. FIG. 3 shows an example of a passenger process in Fast Travel. In this example, a face recognition platform 200 is used to identify a user. The face recognition platform 200 has, for example, face information of a user, information about an aircraft on which a user is scheduled to board, and passport information. The information about the aircraft on which a user is scheduled to board includes information such as the flight number of the aircraft on which a user is scheduled to board, the scheduled boarding time, and a destination. The passport information includes information such as a nationality, a name, a sex, and a date of birth.

When a user checks in at an automatic check-in machine or the like, the face recognition platform 200 identifies the user by using face recognition and issues a single token ST. In the following processes, the single token ST is used. The face recognition platform 200 authenticates a user by using face recognition in the baggage check-in process, the security check process, passport control process, the rebooking process, and the boarding process, respectively. When a system for achieving Fast Travel described above is constructed, the airport user ID acquisition unit 101 can acquire a user ID from the face recognition platform 200. Further, the airport arrival time acquisition unit 102 can acquire the airport arrival time from the face recognition platform 200. The scheduled boarding time acquisition unit 103 can acquire the scheduled boarding time from the face recognition platform 200.

The length of stay information generation unit 104 generates length of stay information of a user based on the airport arrival time acquired by the airport arrival time acquisition unit 102 and the scheduled boarding time acquired by the scheduled boarding time acquisition unit 103. The length of stay information includes a period of time (a length of stay) during which a user stays at the airport. The length of stay can be calculated, for example, by the difference between the arrival time at the airport and the scheduled boarding time. The length of stay information may further include information indicating a time period (a time period of stay) during which a user has arrived at the airport. The time period of stay may be information indicating a time period such as “morning”, “day”, and “night”. The length of stay information generation unit 104 corresponds to the length of stay information generation means 12 shown in FIG. 1.

The behavioral characteristic table 110 stores length of stay information and behavioral characteristics of a user at the airport in association with each other. The behavioral characteristic indicates, for example, a purchase characteristic of a user at a store in the airport. Users have behavioral characteristics such as “users who stay for a long time often use lounges and restaurants”, “users who stay for a medium time often shop at duty-free shops and souvenir shops”, and “users who stay for a short time hardly engage in consumption activities”. The behavioral characteristic table 110 stores, for example, each of a plurality of behavioral characteristics and typical length of stay information of a user having each behavioral characteristic in a manner such that they are associated with each other.

Note that the behavioral characteristic table 110 only needs to be accessible from the behavioral characteristic estimation unit 105 or the like, and is not necessarily included in the benefit distribution apparatus 100. For example, the benefit distribution apparatus 100 and a storage device for storing the behavioral characteristic table 110 may be connected to each other via a network, and the benefit distribution apparatus 100 may access the behavioral characteristic table 110 via the network. The behavioral characteristic table 110 corresponds to the behavioral characteristic table 21 shown in FIG. 1.

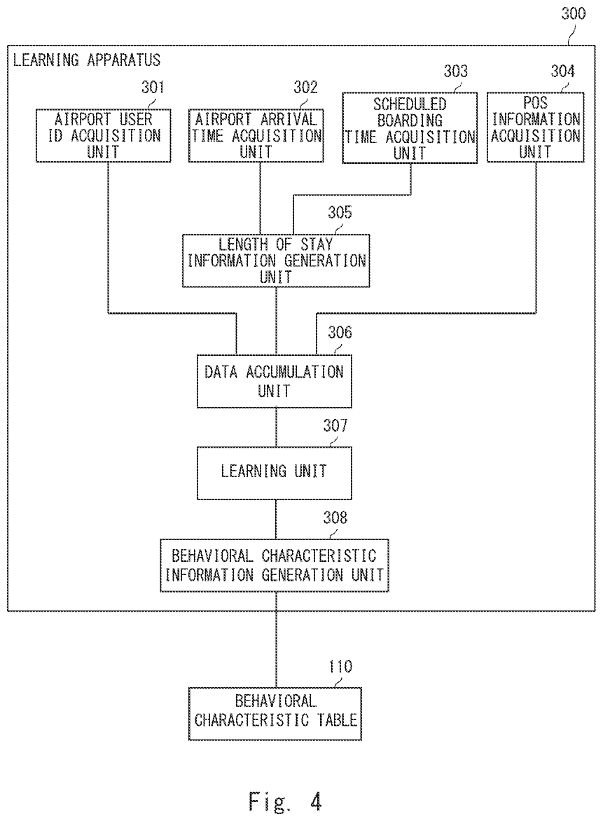

FIG. 4 shows a learning apparatus that can be used to generate the behavioral characteristic table 110. A learning apparatus 300 includes an airport user ID acquisition unit 301, an airport arrival time acquisition unit 302, a scheduled boarding time acquisition unit 303, a point of sale (POS) information acquisition unit 304, a length of stay information generation unit 305, a data accumulation unit 306, a learning unit 307, and a behavioral characteristic information generation unit 308.

The airport user ID acquisition unit 301 acquires identification information (ID) for uniquely identifying a passenger (a user) who is scheduled to board an aircraft. The airport arrival time acquisition unit 302 acquires the time at which a user has arrived at the airport. The scheduled boarding time acquisition unit 303 acquires a scheduled boarding time of the aircraft on which a user boards. The length of stay information generation unit 305 generates length of stay information of a user based on the airport arrival time acquired by the airport arrival time acquisition unit 302 and the scheduled boarding time acquired by the scheduled boarding time acquisition unit 303. The operations of the airport user ID acquisition unit 301, the airport arrival time acquisition unit 302, the scheduled boarding time acquisition unit 303, and the length of stay information generation unit 305, respectively, may be the same as those of the airport user ID acquisition unit 101, the airport arrival time acquisition unit 102, the scheduled boarding time acquisition unit 103, and the length of stay information generation unit 104 shown in FIG. 2.

The POS information acquisition unit 304 acquires POS information of a store in the airport. The data accumulation unit 306 stores length of stay information and information indicating which store a user has used in association with each other each time a user uses the airport. The learning unit 307 learns data stored in the data accumulation unit 306. The learning unit 307 classifies users who have similar length of stay information by unsupervised learning. The learning unit 307 may classify users by using, for example, a cluster analysis. A method of a cluster analysis performed by the learning unit 307 is not limited. The cluster analysis performed by the learning unit 307 may be a hierarchical cluster analysis or a non-hierarchical cluster analysis. When the non-hierarchical cluster analysis is used, any method of cluster analysis is used to determine the number of clusters. A learning method performed by the learning unit 307 is not limited to a cluster analysis, and the learning unit 307 may classify users by using any analysis method.

FIG. 5 shows a specific example of data stored in the data accumulation unit 306. The data accumulation unit 306 generates, based on the POS information acquired by the POS information acquisition unit 304, information (store use information) indicating which store a user has used. The store use information includes information indicating whether or not each store has been used by a user. For example, for each store, the data accumulation unit 306 records “1” in store use information when a user has used the store, while it records “0” in store use information when a user has not used the store.

In the example shown in FIG. 5, the data accumulation unit 306 stores information indicating that a souvenir shop A has been used by a user whose time period of stay is “morning” and whose length of stay is “30 minutes”. Further, the data accumulation unit 306 stores information indicating that a ramen restaurant and the souvenir shop A have been used by a user whose time period of stay is “night” and whose length of stay is “80 minutes”. By using such data, the learning unit 307 classifies users having similar time period of stay and length of stay into clusters. It is assumed that users belonging to the same cluster have similar behavioral characteristics.

The behavioral characteristic information generation unit 308 generates a table associating each cluster with the length of stay information and the store use information of the cluster. The behavioral characteristic information generation unit 308 uses, for example, a typical value (a representative value) of the length of stay information of users belonging to each cluster as length of stay information of the cluster. Further, the behavioral characteristic information generation unit 308 uses a typical value of the store use information of users belonging to each cluster as store use information of the cluster. For example, the behavioral characteristic information generation unit 308 may perform threshold processing on the average value of users belonging to each cluster at a predetermined threshold value (e.g., 0.7) for each store, and when the average value is equal to or greater than the threshold value, the value may be set to “1”, while when the average value is less than the threshold value, the value may be set to “0”. The store use information of each cluster indicates behavioral characteristics (purchase characteristics) of users belonging to each cluster. A method for determining a typical value is determined in accordance with a cluster analysis method. For example, when the k-means method, which is a representative method of a non-hierarchical cluster analysis, is used for a cluster analysis, the behavioral characteristic information generation unit 308 uses the value of the center of gravity of each cluster as the typical value.

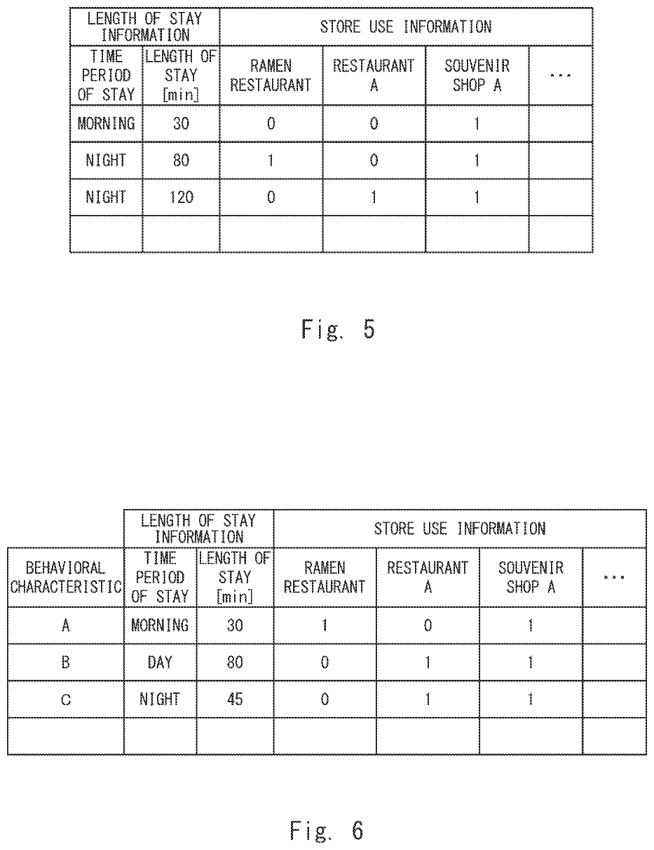

FIG. 6 shows a specific example of a table generated by the behavioral characteristic information generation unit 308. In FIG. 6, the “behavioral characteristics” correspond to the respective clusters. In the example of FIG. 6, for a user belonging to the cluster of a “behavioral characteristic A”, it is shown that the typical value of the time period of stay is “morning”, and the typical value of the length of stay of the user is “30 minutes”. It is also shown that the user belonging to the cluster of the “behavioral characteristic A” typically uses a “ramen restaurant” and the “souvenir shop A”. The behavioral characteristic information generation unit 308 generates and outputs the behavioral characteristic table 110 associating a “behavioral characteristic” with “length of stay information”.

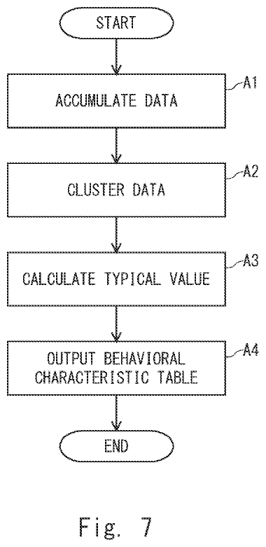

FIG. 7 shows an operation procedure of the learning apparatus 300. The data accumulation unit 306 accumulates information acquired by the airport user ID acquisition unit 301 and the POS information acquisition unit 304 and length of stay information generated by the length of stay information generation unit 305 (Step A1). After data required for learning is accumulated in the data accumulation unit 306, the learning unit 307 classifies the data into a plurality of clusters (Step A2). The behavioral characteristic information generation unit 308 calculates a typical value of each cluster (Step A3). The behavioral characteristic information generation unit 308 generates the behavioral characteristic table 110 associating each cluster with a typical value of the length of stay information (Step A4). In this way, in a learning phase, it is possible to obtain a prediction model that connects a length of stay at the airport with a behavioral characteristic. The generated behavioral characteristic table 110 is used in the benefit distribution apparatus 100 in an operation phase.

Referring again to FIG. 2, the behavioral characteristic estimation unit 105 estimates a behavioral characteristic of a user based on the length of stay information generated by the length of stay information generation unit 104 and the behavioral characteristic table 110. The behavioral characteristic estimation unit 105 calculates, for example, a similarity between the length of stay information generated by the length of stay information generation unit 104 and the “length of stay information” of each behavioral characteristic included in the behavioral characteristic table 110. The behavioral characteristic estimation unit 105 estimates which behavioral characteristic a user has based on the calculated similarities. The behavioral characteristic estimation unit 105 estimates, for example, the behavioral characteristic having the highest similarity to be the behavioral characteristic of the user. The behavioral characteristic estimation unit 105 corresponds to the behavioral characteristic estimation means 13 shown in FIG. 1.

For example, assume a case where the length of stay information generation unit 104 generates, for a certain user X, length of stay information indicating that the time period of stay is “morning” and his/her length of stay is “35 minutes”. In this case, the behavioral characteristic estimation unit 105 calculates a similarity between the length of stay information of the user X and the length of stay information of each of the behavioral characteristics A to C shown in FIG. 6. It is assumed that the similarity between the length of stay information of the user X and the length of stay information of the behavioral characteristic A is 0.7, the similarity between the length of stay information of the user X and the length of stay information of the behavioral characteristic B is 0.2, and the similarity between the length of stay information of the user X and the length of stay information of the behavioral characteristic C is 0.4. In this case, the behavioral characteristic estimation unit 105 estimates that the behavioral characteristic of the user X is the behavioral characteristic A having the highest similarity.

The benefit information table 120 stores a behavioral characteristic and benefit information (coupon information) to be distributed to a user having this behavioral characteristic in association with each other. The benefit determination unit 106 determines coupon information to be distributed to a user based on the behavioral characteristic estimated by the behavioral characteristic estimation unit 105 and the benefit information table 120. When a plurality of pieces of coupon information are stored in association with one behavioral characteristic, the benefit determination unit 106 determines at least some of the plurality of pieces of coupon information as coupon information to be distributed to a user. Note that the benefit information table 120 only needs to be accessible from the benefit determination unit 106 or the like, and is not necessarily included in the benefit distribution apparatus 100. The benefit information table 120 corresponds to the benefit information table 22 shown in FIG. 1, and the benefit determination unit 106 corresponds to the benefit determination means 14 shown in FIG. 1.

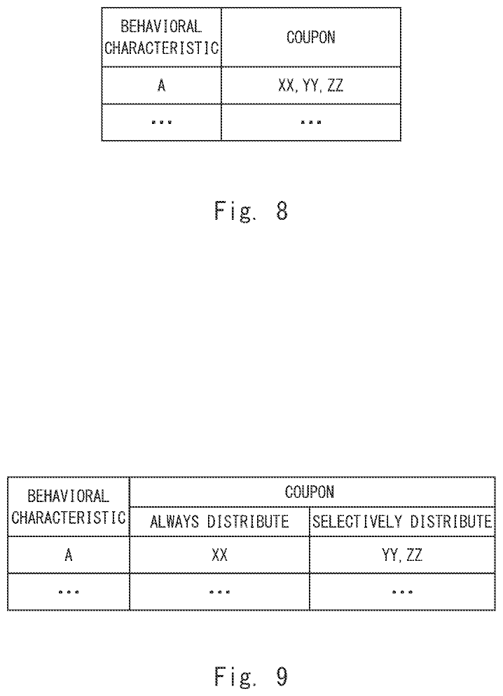

FIG. 8 shows a specific example of the benefit information table 120. In this example, three pieces of coupon information “XX”, “YY”, and “ZZ” are stored in association with the behavioral characteristic A. The coupon information stored in association with each behavioral characteristic is determined, for example, by referring to store use information shown in FIG. 6 obtained by learning. For example, coupon information that can be used at a “ramen restaurant” is stored in association with the behavioral characteristic in which the “ramen restaurant” is “1” in the store use information. Further, coupon information that can be used at the “souvenir shop A” is stored in association with the behavioral characteristic in which the “souvenir shop A” is “1” in the store use information.

The benefit determination unit 106 refers to the benefit information table 120 and determines a coupon to be distributed to a user in accordance with a predetermined rule from among pieces of coupon information stored in association with the estimated behavioral characteristic. For example, when the behavioral characteristic of a user is estimated to be the “behavioral characteristic A”, the benefit determination unit 106 determines “XX”, “YY”, and “ZZ” stored in association with the “behavioral characteristic A” as coupon information to be distributed to the user. Alternatively, the benefit determination unit 106 may randomly select a predetermined number of pieces of coupon information from among “XX”, “YY”, and “ZZ”.

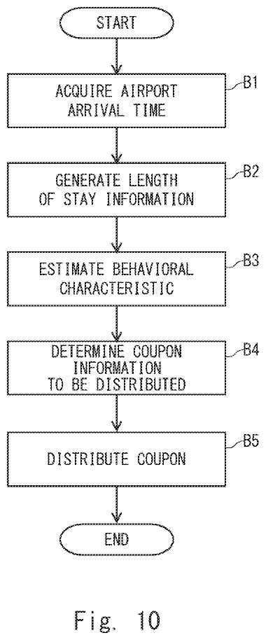

FIG. 9 shows another specific example of the benefit information table 120. In this example, coupon information includes coupon information of a first type that is always distributed, and coupon information of a second type that is selectively distributed. In the example shown in FIG. 9, for the “behavioral characteristic A”, “XX” is stored as coupon information of the first type, and “YY” and “ZZ” are stored as coupon information of the second type. When the benefit information table 120 described above is used, the benefit determination unit 106 may determine, as coupon information to be distributed to a user, coupon information of “XX” and coupon information of either “YY” or “XX”, whichever is, for example, randomly selected.

The benefit transmission unit 107 transmits the coupon information determined by the benefit determination unit 106 to a terminal apparatus 150 carried by a user. The terminal apparatus 150 is configured as a portable information device such as a smartphone, a tablet, or a wearable device. The benefit transmission unit 107 transmits coupon information to the terminal apparatus 150 by using, for example, an e-mail. The benefit transmission unit 107 transmits, for example, an e-mail describing coupon information in its body part to the terminal apparatus 150. Alternatively, the benefit transmission unit 107 may transmit, to the terminal apparatus 150, an e-mail describing in its body part the URL (uniform resource locator) of a web page on which coupon information is posted. Further, the benefit transmission unit 107 may transmit an e-mail to which coupon information is attached as an attached file to the terminal apparatus. When a dedicated application is installed in the terminal apparatus 150, the benefit transmission unit 107 may transmit coupon information to the dedicated application. The benefit transmission unit 107 corresponds to the benefit transmission means 15 shown in FIG. 1.

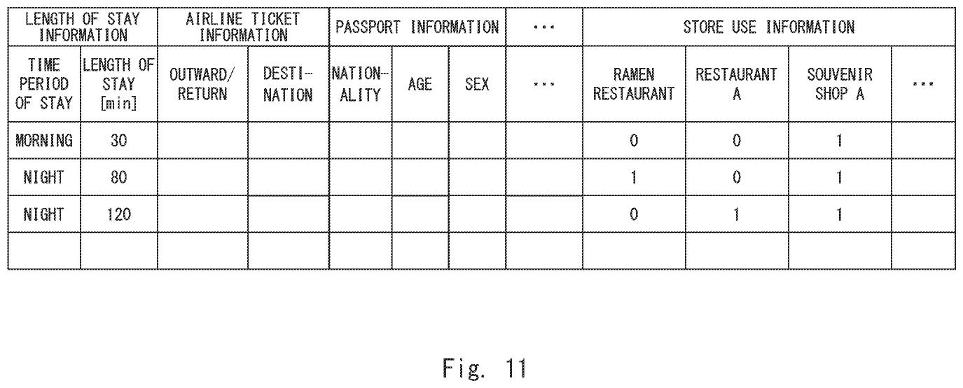

Next, an operation procedure (a benefit distribution method) will be described. FIG. 10 shows the operation procedure of the benefit distribution apparatus 100. The airport arrival time acquisition unit 102 acquires the time at which a user has arrived at an airport (Step B1). The length of stay information generation unit 104 generates length of stay information of the user based on the airport arrival time acquired in Step B1 and the scheduled boarding time acquired by the scheduled boarding time acquisition unit 103 (Step B2). In Step B2, the length of stay information generation unit 104 calculates the difference between the airport arrival time and the scheduled boarding time as a length of stay, and generates length of stay information including the time period of the airport arrival time and the length of stay.

The behavioral characteristic estimation unit 105 refers to the behavioral characteristic table 110 and estimates the behavioral characteristic of the user based on the length of stay information generated in Step B2 (Step B3). In Step B3, the behavioral characteristic estimation unit 105 calculates a similarity between the length of stay information generated in Step B2 and the length of stay information of each behavioral characteristic stored in the behavioral characteristic table 110. The behavioral characteristic estimation unit 105 estimates, for example, the behavioral characteristic having the highest similarity of the length of stay information to be the behavioral characteristic of the user based on the calculated similarities.

The benefit determination unit 106 refers to the benefit information table 120 and determines coupon information to be distributed to the user based on the behavioral characteristic estimated in Step B3 (Step B4). In Step B4, the benefit determination unit 106 selects coupon information to be distributed to the user from among one or more pieces of coupon information stored in association with the estimated behavioral characteristic. The benefit transmission unit 107 transmits the coupon information determined in Step B4 to the terminal apparatus 150 carried by the user (Step B5). In Step B5, the benefit transmission unit 107 transmits the coupon information to the user by using, for example, e-mail.

In this example embodiment, the behavioral characteristic table 110 associating a length of stay of an airport user at the airport with a behavioral characteristic of the airport user is used. The behavioral characteristic estimation unit 105 estimates a behavioral characteristic of a user from the length of stay of the user by using the behavioral characteristic table 110. The benefit determination unit 106 refers to the benefit information table 120 and determines coupon information corresponding to the estimated behavioral characteristic as coupon information to be distributed to the user. By doing so, it is possible to distribute, to a user, the coupon information suitable for the behavioral characteristic of the user in accordance with the length of his/her stay at the airport.

It should be noted that, in Patent Literature 1, a coupon is distributed based on the length of stay of a user and the time required in a store. For example, in Patent Literature 1, only time is paid attention to, coupons for, for example, a “small souvenir shop” where it does not take much time to choose souvenirs, a “ramen restaurant” which quickly serves meals and where it takes a short time to eat meals, are distributed to a user who has arrived at the airport shortly before the scheduled boarding time. However, a user who has arrived shortly before the scheduled boarding time does not have enough time to eat ramen. An airport user who uses a ramen restaurant may be a person who stays for a long time. An airport user who stays for a long time may use a ramen restaurant and take more time to choose souvenirs at a souvenir shop. As described above, the behavioral characteristic of an airport user cannot be determined simply by a “length of stay” and a “time required for an event”.

In this example embodiment, for example, in the learning phase, the learning apparatus 300 is used to generate the prediction model (the behavioral characteristic table 110) that connects the length of stay at the airport with the behavioral characteristic. In the operation phase, it is estimated what type of a behavioral characteristic a user who is scheduled to board an aircraft has from his/her length of stay, and coupon information corresponding to the estimated behavioral characteristic is distributed to the user. By doing so, it is possible to distribute, to a user, coupon information that meets the needs of the user, and accordingly it can be expected that the coupon information will be used by the user. Thus, it is possible to increase the sales of the stores in the airport.

Next, a second example embodiment of the present disclosure will be described. The configuration of a benefit distribution apparatus according to the second example embodiment may be similar to that of the benefit distribution apparatus 100 according to the first example embodiment shown in FIG. 2. In this example embodiment, the behavioral characteristic estimation unit 105 estimates a percentage of each of a plurality of behavioral characteristics possessed by a user. The benefit determination unit 106 selects coupon information to be distributed to a user in accordance with the percentage of each of the behavioral characteristics estimated by the behavioral characteristic estimation unit 105. The configurations other than the above configuration may be similar to those of the first example embodiment.

In this example embodiment, the behavioral characteristic estimation unit 105 calculates a similarity between length of stay information generated by the length of stay information generation unit 104 and the “length of stay information” of each of the behavioral characteristics included in the behavioral characteristic table 110. The behavioral characteristic estimation unit 105 estimates the percentage of each of the behavioral characteristics possessed by a user based on the ratio between the calculated similarities. Specifically, it is assumed that the similarity between the length of stay information of a certain user X and the length of stay information of the behavioral characteristic A is 0.7. Further, the similarity between the length of stay information of the user X and the length of stay information of the behavioral characteristic B is 0.2 and the similarity between the length of stay information of the user X and the length of stay information of the behavioral characteristic C is 0.4. In this case, the percentage of the behavioral characteristic A of the user X can be calculated as 0.7/(0.7+0.2+0.4)≈0.54. Similarly, the percentage of the behavioral characteristic B of the user X can be calculated as 0.2/(0.7+0.2+0.4)≈0.15, and the percentage of the behavioral characteristic C of the user X can be calculated as 0.7/(0.7+0.2+0.4)≈0.31.

In this example embodiment, the benefit determination unit 106 allocates the total number of pieces of coupon information to be distributed to a user among the behavioral characteristics in accordance with the percentage of each of the behavioral characteristics, and determines the number of pieces of coupon information to be distributed corresponding to each of the behavioral characteristics. More specifically, the benefit determination unit 106 determines the number of pieces of coupon information to be distributed corresponding to each of the behavioral characteristics, for example, in the following procedure. First, the benefit determination unit 106 defines the total number of pieces of coupon information to be distributed. Next, the benefit determination unit 106 determines the number of pieces of coupon information to be distributed corresponding to each of the behavioral characteristics by multiplying the total number of pieces of coupon information by the percentage of each of the behavioral characteristics and then rounding it off to the first decimal place. The benefit determination unit 106, for each of the behavioral characteristics, selects pieces of coupon information equal in number to the pieces of coupon information allocated to each of the behavioral characteristics from among the pieces of coupon information stored in association with the respective behavioral characteristics in the benefit information table 120, and thereby determines coupon information to be distributed to a user. The benefit determination unit 106 randomly selects a determined number of pieces of coupon information to be distributed, for example, from among the pieces of coupon information stored in association with the respective behavioral characteristics in the benefit information table 120.

In this example embodiment, like in the first example embodiment, as shown in FIG. 9, the benefit information table 120 may store coupon information of the first type and coupon information of the second type. In this case, the benefit determination unit 106 may determine, as pieces of coupon information to be distributed to a user, the coupon information of the first type and the coupon information randomly selected from the pieces of coupon information of the second type. Alternatively, the benefit information table 120 may store coupon information for each of the behavioral characteristics in accordance with the order of priority. In this case, the benefit determination unit 106 may select, for each of the behavioral characteristics, a determined number of pieces of coupon information to be distributed from among the pieces of coupon information having a high priority.

In this example embodiment, the behavioral characteristic estimation unit 105 estimates the percentage of each of the behavioral characteristics possessed by a user. The benefit determination unit 106 determines coupon information corresponding to each of the behavioral characteristics as coupon information to be distributed to a user in accordance with the percentage of each of the behavioral characteristics. By doing so, it is possible to distribute coupon information corresponding to the needs of a user in accordance with the percentage of each of the behavioral characteristics. Effects other than the above effect are similar to those in the first example embodiment.

Note that in the above example embodiments, the behavioral characteristic estimation unit 105 estimates the behavioral characteristic based on information about the length of stay of a user, but the behavioral characteristic estimation unit 105 may instead estimate the behavioral characteristic using other information in addition to the length of stay. For example, the behavioral characteristic estimation unit 105 may estimate the behavioral characteristic using at least one of information (airline ticket information) about the aircraft on which a user is scheduled to board and attribute information of a user in addition to the length of stay information. The airline ticket information and the attribute information of a user can be obtained, for example, from the face recognition platform 200 shown in FIG. 3.

In the above case, a table associating the length of stay information, the airline ticket information, and the attribute information of a user with the behavioral characteristic is used as the behavioral characteristic table 110. The behavioral characteristic estimation unit 105 calculates a similarity between the length of stay information, the airline ticket information, and the user attribute information of each of the behavioral characteristics in the behavioral characteristic table 110 and the length of stay information, the airline ticket information, and the user attribute information of a user to whom coupon information is distributed, respectively. The behavioral characteristic estimation unit 105 estimates the behavioral characteristic of the user based on the calculated similarities. The aforementioned behavioral characteristic table 110 can be created by, for example, using the learning apparatus 300 shown in FIG. 4 and causing it to learn data in which the length of stay information, the airline ticket information, and the attribute information of a user are associated with the POS information.

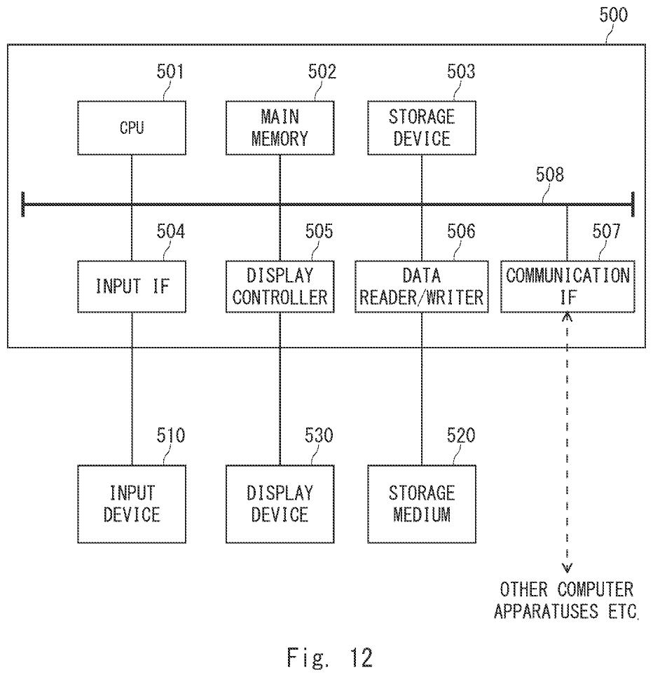

FIG. 11 shows a specific example of data accumulated in the learning apparatus 300 in the above case. In this example, passport information of a user is used as attribute information of a user. The learning apparatus 300 uses an airline ticket information acquisition unit and a passport information acquisition unit, which are not shown in FIG. 4, to acquire airline ticket information and passport information of a user. The airline ticket information includes, for example, information indicating whether the route is an outward route or a return route, and information indicating a destination. The passport information includes, for example, information indicating a nationality, an age, and a sex. The data accumulation unit 306 stores information (store use information) indicating which store a user has used in association with the length of stay information, the airline ticket information, the passport information, and the like.

The learning unit 307 performs a cluster analysis on data stored in the aforementioned data accumulation unit 306, and classifies users having similar length of stay information, airline ticket information, passport information, and the like into clusters. The behavioral characteristic information generation unit 308 calculates typical values of the length of stay information, the airline ticket information, and the passport information for each cluster, and generates the behavioral characteristic table 110 associating the calculated typical values with the respective behavioral characteristics. By using other information such as airline ticket information and passport information in addition to length of stay time information, it is considered that the accuracy of estimation of the behavioral characteristic of a user can be improved.

Note that, in the above example embodiments, the benefit distribution apparatus 100 (see FIG. 2) and the learning apparatus 300 (see FIG. 4) can be configured using computer apparatuses. FIG. 12 shows a configuration example of the computer apparatus. A computer apparatus 500 includes a Central Processing Unit (CPU) 501, a main memory 502, a storage device 503, an input interface 504, a display controller 505, a data reader/writer 506, and a communication interface 507. In the computer apparatus 500, these components are connected to each other via a bus 508 so that they can perform data communication.

The CPU 501 executes various types of operations by developing a program (a code) stored in the storage device 503 in the main memory 502 and executing the program. The main memory 502 is typically a volatile storage device such as a Dynamic Random Access Memory (DRAM). A program for causing the computer apparatus 500 to function as the benefit distribution apparatus 100 or the learning apparatus 300 is provided, for example, in a state in which it is stored in a computer-readable storage medium 520. The program may be provided through a network, such as the Internet connected via the communication interface 507.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disks, etc.), optical magnetic storage media (such as magneto-optical disks), optical disc media (such as CD (compact disc), DVD (digital versatile disc), etc.), and semiconductor memories (such as mask ROM (read only memory), PROM (programmable ROM), EPROM (erasable PROM), flash ROM, RAM (random access memory), etc.). Further, the program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The storage device 503 is configured as a disk device such as a hard disk drive or a semiconductor storage device such as a flash memory. The input interface 504 mediates data transmission between the CPU 501 and input devices 510 such as a keyboard and a mouse. The display controller 505 is connected to a display device 530 and controls display on the display device 530. The data reader/writer 506 mediates data transmission between the CPU 501 and the storage medium 520. The data reader/writer 506 reads a program, for example, from the storage medium 520 and transmits the read program to the CPU 501. The communication interface 507 mediates data transmission between the CPU 501 and other computers.

Although the present disclosure has been described with reference to the example embodiments, the present disclosure is not limited by the above. The configuration and details of the present disclosure may be modified in various ways as will be understood by those skilled in the art within the scope of the disclosure.

For example, the whole or part of the example embodiments disclosed above can be described as, but not limited to, the following supplementary notes.

### Supplementary Note 1

A benefit distribution apparatus comprising:

arrival time acquisition means for acquiring a time at which a user who is scheduled to board an aircraft has arrived at an airport;

length of stay information generation means for calculating a length of stay based on the time at which the user has arrived at the airport and a scheduled boarding time of the aircraft on which the user is scheduled to board and generating length of stay information including the length of stay;

behavioral characteristic estimation means for estimating a behavioral characteristic of the user based on and a behavioral characteristic table in which length of stay information and behavioral characteristics of a user at the airport are stored in association with each other;

benefit determination means for referring to a benefit information table in which the behavioral characteristic and one or more pieces of benefit information to be distributed are stored in association with each other and determining the benefit information to be distributed to the user based on the estimated behavioral characteristic; and

benefit transmission means for transmitting the benefit information determined by the benefit determination means to a terminal apparatus carried by the user.

### Supplementary Note 2

The benefit distribution apparatus according to Supplementary note 1, wherein the behavioral characteristic estimation means calculates a similarity between the length of stay information stored in association with each of the behavioral characteristics in the behavioral characteristic table and the length of stay information generated by the length of stay information generation means, and estimates the behavioral characteristic of the user based on the calculated similarities.

### Supplementary Note 3

The benefit distribution apparatus according to Supplementary note 2, wherein the behavioral characteristic estimation means estimates the behavioral characteristic having the highest calculated similarity among the behavioral characteristics stored in the behavioral characteristic table to be the behavioral characteristic of the user.

### Supplementary Note 4

The benefit distribution apparatus according to Supplementary note 3, wherein the benefit determination means determines, as the benefit information to be distributed to the user, at least some of the one or more pieces of the benefit information stored in association with the estimated behavioral characteristic in the benefit information table.

### Supplementary Note 5

The benefit distribution apparatus according to Supplementary note 3, wherein the benefit determination means determines, as the benefit information to be distributed to the user, a predetermined number of pieces of the benefit information randomly selected from the one or more pieces of the benefit information stored in association with the estimated behavioral characteristic in the benefit information table.

### Supplementary Note 6

The benefit distribution apparatus according to Supplementary note 2, wherein the behavioral characteristic estimation means estimates a percentage of each of the behavioral characteristics that are stored in the behavioral characteristic table and that are possessed by the user based on a ratio between the calculated similarities.

### Supplementary Note 7

The benefit distribution apparatus according to Supplementary note 6, wherein the benefit determination means determines the benefit information to be distributed to the user based on the percentage of each of the behavioral characteristics possessed by the user.

### Supplementary Note 8

The benefit distribution apparatus according to Supplementary note 7, wherein the benefit determination means allocates a total number of pieces of the benefit information to be distributed to the user among the behavioral characteristics in accordance with the percentage of each of the behavioral characteristics, selects, for each of the behavioral characteristics, pieces of the benefit information equal in number to the pieces of the benefit information allocated to each of the behavioral characteristics from among the pieces of the benefit information stored in association with the respective behavioral characteristics in the benefit information table, and thereby determines the benefit information to be distributed to the user.

### Supplementary Note 9

The benefit distribution apparatus according to Supplementary note 1, wherein

the behavioral characteristic table further stores at least one of information about an aircraft and attribute information of a user in association with the length of stay information and the behavioral characteristic, and

a similarity of the length of stay information stored in association with each of the behavioral characteristics in the behavioral characteristic table and at least one of the information about an aircraft and the attribute information of the user to the length of stay information generated by the length of stay information generation means and at least one of information about an aircraft to be used by the user and the attribute information of the user is calculated, and the behavioral characteristic of the user is estimated based on the calculated similarities.

### Supplementary Note 10

The benefit distribution apparatus according to any one of Supplementary notes 1 to 9, wherein

the benefit information table stores a plurality of pieces of the benefit information in association with the behavioral characteristic, and the plurality of pieces of the benefit information include the benefit information of a first type and one or more pieces of the benefit information of a second type, and

the benefit determination means determines, as the benefit information to be distributed to the user, the benefit information of the first type and a predetermined number of pieces of the benefit information selected from among the one or more pieces of the benefit information of the second type.

### Supplementary Note 11

The benefit distribution apparatus according to any one of Supplementary notes 1 to 10, wherein the arrival time acquisition means acquires, as the time at which the user has arrived at the airport, one of a time at which the user has checked in using a terminal installed in the airport, a time at which the user has checked his/her baggage in, and a time at which the user has passed through a security checkpoint.

### Supplementary Note 12

The benefit distribution apparatus according to any one of Supplementary notes 1 to 11, wherein the length of stay information further includes information indicating a time period of the acquired time at which the user has arrived at the airport.

### Supplementary Note 13

A benefit distribution method comprising:

acquiring a time at which a user who is scheduled to board an aircraft has arrived at an airport;

calculating a length of stay based on the time at which the user has arrived at the airport and a scheduled boarding time of the aircraft on which the user is scheduled to board and generating length of stay information including the length of stay;

estimating a behavioral characteristic of the user based on a behavioral characteristic table in which length of stay information and behavioral characteristics of a user at the airport are stored in association with each other;

referring to a benefit information table in which the behavioral characteristic and one or more pieces of benefit information to be distributed are stored in association with each other and determining the benefit information to be distributed to the user based on the estimated behavioral characteristic; and

transmitting the determined benefit information to a terminal apparatus carried by the user.

### Supplementary Note 14

A program for causing a computer to: acquire a time at which a user who is scheduled to board an aircraft has arrived at an airport;

calculate a length of stay based on the time at which the user has arrived at the airport and a scheduled boarding time of the aircraft on which the user is scheduled to board and generate length of stay information including the length of stay;

estimate a behavioral characteristic of the user based on a behavioral characteristic table in which length of stay information and behavioral characteristics of a user at the airport are stored in association with each other;

refer to a benefit information table in which the behavioral characteristic and one or more pieces of benefit information to be distributed are stored in association with each other and determine the benefit information to be distributed to the user based on the estimated behavioral characteristic; and

transmit the determined benefit information to a terminal apparatus carried by the user.

This application is based upon and claims the benefit of priority from Japanese patent application No. 2018-229184, filed on Dec. 6, 2018, the disclosure of which is incorporated herein in its entirety by reference.

### REFERENCE SIGNS LIST

10 BENEFIT DISTRIBUTION APPARATUS
11 ARRIVAL TIME ACQUISITION MEANS
12 LENGTH OF STAY INFORMATION GENERATION MEANS
13 BEHAVIORAL CHARACTERISTIC ESTIMATION MEANS
14 BENEFIT DETERMINATION MEANS
15 BENEFIT TRANSMISSION MEANS
21 BEHAVIORAL CHARACTERISTIC TABLE
22 BENEFIT INFORMATION TABLE
100 BENEFIT DISTRIBUTION APPARATUS
101 AIRPORT USER ID ACQUISITION UNIT
102 AIRPORT ARRIVAL TIME ACQUISITION UNIT
103 SCHEDULED BOARDING TIME ACQUISITION UNIT
104 LENGTH OF STAY INFORMATION GENERATION UNIT
105 BEHAVIORAL CHARACTERISTIC ESTIMATION UNIT
106 BENEFIT DETERMINATION UNIT
107 BENEFIT TRANSMISSION UNIT
110 BEHAVIORAL CHARACTERISTIC TABLE
120 BENEFIT INFORMATION TABLE
150 TERMINAL APPARATUS
200 FACE RECOGNITION PLATFORM
300 LEARNING APPARATUS
301 AIRPORT USER ID ACQUISITION UNIT
302 AIRPORT ARRIVAL TIME ACQUISITION UNIT
303 SCHEDULED BOARDING TIME ACQUISITION UNIT
304 POS INFORMATION ACQUISITION UNIT
305 LENGTH OF STAY INFORMATION GENERATION UNIT
306 DATA ACCUMULATION UNIT
307 LEARNING UNIT
308 BEHAVIORAL CHARACTERISTIC INFORMATION GENERATION UNIT
500 COMPUTER APPARATUS
502 MAIN MEMORY
503 STORAGE DEVICE
504 INPUT INTERFACE
505 DISPLAY CONTROLLER
506 DATA READER/WRITER
507 COMMUNICATION INTERFACE
508 BUS
510 INPUT DEVICE
520 STORAGE MEDIUM
530 DISPLAY DEVICE

What is claimed is:

1. A benefit distribution apparatus comprising:
at least one memory storing instructions, and
at least one processor configured to execute the instructions to implement;
an arrival time acquisition unit configured to acquire a time at which a user who is scheduled to board an aircraft has arrived at an airport;
a length of stay information generation unit configured to calculate a length of stay based on the time at which the user has arrived at the airport and a scheduled boarding time of the aircraft on which the user is scheduled to board and generate length of stay information including the length of stay;
a behavioral characteristic estimation unit configured to estimate a behavioral characteristic of the user based on the generated length of stay information and a behavioral characteristic table in which length of stay information and behavioral characteristics of a user at the airport are stored in association with each other;
a benefit determination unit configured to refer to a benefit information table in which the behavioral characteristic and one or more pieces of benefit information to be distributed are stored in association with each other and determine the benefit information to be distributed to the user based on the estimated behavioral characteristic; and
a benefit transmission unit configured to transmit the benefit information determined by the benefit determination unit to a terminal apparatus carried by the user.

2. The benefit distribution apparatus according to claim 1, wherein the behavioral characteristic estimation unit is configured to calculate a similarity between the length of stay information stored in association with each of the behavioral characteristics in the behavioral characteristic table and the length of stay information generated by the length of stay information generation unit, and estimate the behavioral characteristic of the user based on the calculated similarities.

3. The benefit distribution apparatus according to claim 2, wherein the behavioral characteristic estimation unit is configured to estimate the behavioral characteristic having the highest calculated similarity among the behavioral characteristics stored in the behavioral characteristic table to be the behavioral characteristic of the user.

4. The benefit distribution apparatus according to claim 3, wherein the benefit determination unit is configured to determine, as the benefit information to be distributed to the user, at least some of the one or more pieces of the benefit information stored in association with the estimated behavioral characteristic in the benefit information table.

5. The benefit distribution apparatus according to claim 3, wherein the benefit determination unit is configured to determine, as the benefit information to be distributed to the user, a predetermined number of pieces of the benefit information randomly selected from the one or more pieces of the benefit information stored in association with the estimated behavioral characteristic in the benefit information table.

6. The benefit distribution apparatus according to claim 2, wherein the behavioral characteristic estimation unit is configured to estimate a percentage of each of the behavioral characteristics that are stored in the behavioral characteristic table and that are possessed by the user based on a ratio between the calculated similarities.

7. The benefit distribution apparatus according to claim 6, wherein the benefit determination unit is configured to determine the benefit information to be distributed to the user based on the percentage of each of the behavioral characteristics possessed by the user.

8. The benefit distribution apparatus according to claim 7, wherein the benefit determination unit is configured to allocate a total number of pieces of the benefit information to be distributed to the user among the behavioral characteristics in accordance with the percentage of each of the behavioral characteristics select, for each of the behavioral characteristics, pieces of the benefit information equal in number to the pieces of the benefit information allocated to each of the behavioral characteristics from among the pieces of the benefit information stored in association with the respective behavioral characteristics in the benefit information table, and thereby determine the benefit information to be distributed to the user.

9. The benefit distribution apparatus according to claim 1, wherein
the behavioral characteristic table further stores at least one of information about an aircraft and attribute information of a user in association with the length of stay information and the behavioral characteristic, and
the behavioral characteristic estimation unit is configured to calculate a similarity of the length of stay information stored in association with each of the behavioral characteristics in the behavioral characteristic table and at least one of the information about an aircraft and the attribute information of the user to the length of stay information generated by the length of stay information generation unit and at least one of information about an aircraft to be used by the user and the attribute information of the user, and estimate the behavioral characteristic of the user based on the calculated similarities.

10. The benefit distribution apparatus according to claim 1, wherein
the benefit information table stores a plurality of pieces of the benefit information in association with the behavioral characteristic, and the plurality of pieces of the benefit information include the benefit information of a first type and one or more pieces of the benefit information of a second type, and
the benefit determination unit is configured to determine, as the benefit information to be distributed to the user, the benefit information of the first type and a predetermined number of pieces of the benefit information selected from among the one or more pieces of the benefit information of the second type.

11. The benefit distribution apparatus according to claim 1, wherein the arrival time acquisition unit is configured to acquire, as the time at which the user has arrived at the airport, one of a time at which the user has checked in using a terminal installed in the airport, a time at which the user has checked his/her baggage in, and a time at which the user has passed through a security checkpoint.

12. The benefit distribution apparatus according to claim 1, wherein the length of stay information further includes information indicating a time period of the acquired time at which the user has arrived at the airport.

13. A benefit distribution method comprising:
acquiring a time at which a user who is scheduled to board an aircraft has arrived at an airport;
calculating a length of stay based on the time at which the user has arrived at the airport and a scheduled boarding time of the aircraft on which the user is scheduled to board and generating length of stay information including the length of stay;
estimating a behavioral characteristic of the user based on the generated length of stay information and a behavioral characteristic table in which length of stay information and behavioral characteristics of a user at the airport are stored in association with each other;
referring to a benefit information table in which the behavioral characteristic and one or more pieces of benefit information to be distributed are stored in association with each other and determining the benefit information to be distributed to the user based on the estimated behavioral characteristic; and
transmitting the determined benefit information to a terminal apparatus carried by the user.

14. A non-transitory computer readable medium storing a program for causing a computer to:
acquire a time at which a user who is scheduled to board an aircraft has arrived at an airport;
calculate a length of stay based on the time at which the user has arrived at the airport and a scheduled boarding time of the aircraft on which the user is scheduled to board and generate length of stay information including the length of stay;
estimate a behavioral characteristic of the user based on the generated length of stay information and a behavioral characteristic table in which length of stay information and behavioral characteristics of a user at the airport are stored in association with each other;
refer to a benefit information table in which the behavioral characteristic and one or more pieces of benefit information to be distributed are stored in association with each other and determine the benefit information to be distributed to the user based on the estimated behavioral characteristic; and
transmit the determined benefit information to a terminal apparatus carried by the user.
